(19) United States
(12) Patent Application Publication
(10) Pub. No.: US 2018/0305048 A1
(43) Pub. Date: Oct. 25, 2018

(54) PAPER SHEET HANDLING APPARATUS AND PAPER SHEET HANDLING METHOD

(71) Applicant: GLORY LTD., Hyogo (JP)

(72) Inventors: Kazuaki NISHIMURA, Himeji-shi (JP); Youichi TAKEMURA, Himeji-shi (JP); Ryosuke KONO, Himeji-shi (JP)

(73) Assignee: GLORY LTD., Hyogo (JP)

(21) Appl. No.: 15/954,134

(22) Filed: Apr. 16, 2018

(30) Foreign Application Priority Data
Apr. 19, 2017 (JP) 2017-082791

(51) Int. Cl. B65B 7/14; G07D 11/00

(52) U.S. Cl. CPC B65B 7/14; G07D 11/0021; G07D 11/0009; G07D 11/0018; G07D 7/181; G07D 11/0036; G07D 2211/00; G07D 2207/00; G07D 11/0051

(57) ABSTRACT

A paper sheet handling apparatus (for example, a banknote handling apparatus) includes a holding unit (for example, each holding member) which holds a portion of the storage bag near an opening thereof, a sealing unit (for example, each heating member) which seals the opening of the storage bag held by the holding unit, and a placement unit (for example, each stage) that is movable in a substantially vertical direction and on which at least a part of the storage bag held by the holding unit is placed. When a sealing process is performed, the placement unit on which at least a part of the storage bag held by the holding unit is placed is raised.

### CROSS-REFERENCE TO RELATED APPLICATION

This application claims priority to Japanese Patent Application No. 2017-082791 filed on Apr. 19, 2017, the entire contents of which are incorporated herein by reference.

### BACKGROUND OF THE INVENTION

### 1. Field of the Invention

The present invention relates to a paper sheet handling apparatus for storing paper sheets inside a storage bag provided with an opening, and a paper sheet handling method performed by the paper sheet handling apparatus.

### 2. Description of the Related Art

As a paper sheet handling apparatus for depositing paper sheets such as banknotes and the like, there has been conventionally used one in which the paper sheets taken in a housing are stored in a storage bag such as a pouch bag and the like. Such a paper sheet handling apparatus is used as a part of a cash teller machine installed in a back office floor in a store such as a supermarket, and the cash teller machine dispenses the money as a change fund to be replenished to a cash settlement machine installed in a sales floor, and deposits the money as a sales proceeds collected from the cash settlement machine. As such a paper sheet handling apparatus, for example, one disclosed in International Patent Publication WO2016/136517 and the like is known.

In the banknote handling apparatus disclosed in WO2016/136517, there is provided a banknote storage mechanism for storing the banknotes inside the storage bag provided with an opening on one side, in a stacked state. More specifically, in the banknote storage mechanism, a pair of holding members is provided so as to be separated from each other and opposed to each other. Two opposing portions of the storage bag near the opening thereof are held by each holding member. Each holding member is provided with a heating member. Then, in the banknote storage mechanism, after a predetermined amount of banknotes are stored in a stacked state in the storage bag held by each holding member, before the storage bag is taken out from the banknote storage mechanism, when one holding member moves toward the other holding member and these holding members are in contact with each other, heat is applied to a portion of the storage bag near the opening thereof by the heating member, whereby the opening of the storage bag is heat-sealed. In addition, the banknote storage mechanism also includes a stage on which the bottom of the storage bag held by the pair of holding members is placed. Then, each time the banknote is stored in the storage bag held by the pair of holding members, the stage is gradually lowered, thereby maintaining a space for storing the banknotes inside the storage bag.

### SUMMARY OF THE INVENTION

In the banknote handling apparatus disclosed in WO2016/136517, when a large amount of banknotes are stored in the storage bag, the weight of the stored banknotes is loaded near the opening of the storage bag, and there is a fear that the end portion of the storage bag hangs down. If the end portion of the storage bag hangs down, there is a problem that a seal failure occurs when the opening of the storage bag is heat-sealed. In addition, if the weight of the stored banknotes is loaded to the storage bag, a tension applied to the storage bag becomes large, and then there is a fear that the opening of the storage bag can not be properly heat-sealed. There is a similar problem in a banknote handling apparatus in which the opening of the storage bag is sealed with a bonding material.

The present invention has been made in view of these points, and it is an object of the present invention to provide a paper sheet handling apparatus and a paper sheet handling method capable of properly performing a sealing process to seal the opening of the storage bag.

A paper sheet handling apparatus of the present invention for storing a paper sheet inside a storage bag provided with an opening includes: a holding unit which holds a portion of the storage bag near the opening thereof; a sealing unit which seals the opening of the storage bag held by the holding unit; a placement unit that is movable in a substantially vertical direction and on which at least a part of the storage bag held by the holding unit is placed; a driving unit which moves the placement unit in the substantially vertical direction; and a control unit which controls the driving unit such that when a sealing process for sealing the opening of the storage bag held by the holding unit with the sealing unit is performed, the placement unit on which at least a part of the storage bag held by the holding unit is placed is raised.

In the paper sheet handling apparatus of the present invention, the control unit may control the driving unit such that the placement unit is raised before the opening of the storage bag held by the holding unit is sealed by the sealing unit.

In this case, the holding unit may include a pair of holding members, at least one of the holding members may be movable in a direction toward and away from the other holding member, and the storage bag may be sandwiched between the holding members when the holding members approach, the sealing unit may seal the opening of the storage bag sandwiched between the holding members, and the control unit may control the driving unit such that the placement unit on which at least a part of the storage bag held by the holding unit is placed is raised before sandwiching the storage bag between the holding members.

Further, the placement unit may include a pair of placement members, at least one of the placement members may be movable in a direction toward and away from the other placement member, and the storage bag may be sandwiched between the placement members when the placement members approach, and the control unit may control the driving unit such that the placement unit on which at least a part of the storage bag held by the holding unit is placed is raised after sandwiching the storage bag between the placement members.

Further, the control unit may control the driving unit such that at least one of the holding members is moved in a direction of approaching the other holding member so that a distance between the holding members is reduced to such an extent that the storage bag is not sandwiched between the holding members, and thereafter the placement unit is raised.

In the paper sheet handling apparatus of the present invention, the holding unit may include a pair of holding members, at least one of the holding members may be movable in a direction toward and away from the other holding member, and the storage bag may be sandwiched between the holding members when the holding members approach, the sealing unit may seal the opening of the storage bag sandwiched between the holding members, and the control unit may control the driving unit such that the placement unit on which at least a part of the storage bag held by the holding unit is placed is raised after sandwiching the storage bag between the holding members.

In this case, the control unit may control the driving unit such that the placement unit on which at least a part of the storage bag held by the holding unit is placed is raised before sandwiching the storage bag between the holding members, thereafter sandwiching the storage bag between the holding members, and then the placement unit is further raised after sandwiching the storage bag between the holding members.

In the paper sheet handling apparatus of the present invention, the control unit may control the driving unit such that the placement unit is raised after the opening of the storage bag held by the holding unit is sealed by the sealing unit.

In this case, the placement unit may include a pair of placement members, at least one of the placement members may be movable in a direction toward and away from the other placement member, and the storage bag may be sandwiched between the placement members when the placement members approach, and the control unit may control the driving unit such that after the opening of the storage bag held by the holding unit is sealed by the sealing unit, the placement members are separated from each other, and thereafter the placement unit is raised.

Further, a heat bonding member may be provided for thermally bonding and sealing a portion to be a bottom part of the storage bag when the paper sheet is stored therein, and each placement member may be separated from each other after the portion to be the bottom part of the storage bag is sealed by the heat bonding member.

Further, after the opening of the storage bag held by the holding unit is sealed by the sealing unit, the portion to be the bottom part of the storage bag may be sealed by the heat bonding member.

In the paper sheet handling apparatus of the present invention, the control unit may control the driving unit such that after the placement unit is lowered, the placement unit is raised.

A paper sheet handling method of the present invention for storing a paper sheet inside a storage bag provided with an opening includes the steps of: holding a portion of the storage bag near the opening thereof by a holding unit, and placing at least a part of the storage bag held by the holding unit on a placement unit that is movable in a substantially vertical direction; storing a paper sheet inside the storage bag held by the holding unit; and performing a sealing process for sealing the opening of the storage bag held by the holding unit; and when the sealing process is performed, the placement unit on which at least a part of the storage bag held by the holding unit is placed is raised.

### BRIEF DESCRIPTION OF THE DRAWINGS

FIG. 1 is a perspective view showing an external appearance of a money handling machine according to an embodiment of a present invention.

FIG. 2 is a side view showing an internal configuration of a banknote handling apparatus in the money handling machine shown in FIG. 1.

FIG. 3 is a side view showing a detail of a configuration of a banknote storage mechanism in the banknote handling apparatus shown in FIG. 2.

FIG. 4 is a perspective view showing a configuration of a pair of holding members and the like of the banknote storage mechanism shown in FIG. 3.

FIG. 5 is a perspective view showing a configuration of a storage bag to be held by each holding member of the banknote storage mechanism shown in FIG. 3 and the like.

FIG. 6 is a perspective view showing a state in which the storage bag is held by each holding member of the banknote storage mechanism shown in FIG. 3 and the like.

FIG. 7 is a perspective view showing a state in which an end portion of the storage bag near an opening thereof hangs down as banknotes are stored in the storage bag shown in FIG. 6.

FIG. 8 is a functional block diagram showing a configuration of a control system of the banknote handling apparatus shown in FIG. 2 and the like.

FIG. 9 is an explanatory diagram sequentially showing an operation of sealing the opening of the storage bag in which the banknotes are stored in the banknote storage mechanism shown in FIG. 3 and the like.

FIG. 10 shows the operation of sealing the opening of the storage bag in which the banknotes are stored in the banknote storage mechanism shown in FIG. 3 and the like following the state shown in (f) of FIG. 9.

FIG. 11 is an explanatory diagrams sequentially showing an operation of sealing the opening of the storage bag in which the banknotes are stored in a banknote storage mechanism according to a modified example.

FIG. 12 shows the operation of sealing the opening of the storage bag in which the banknotes are stored in the banknote storage mechanism according to the modified example following the state shown in (f) of FIG. 11.

### DESCRIPTION OF THE PREFERRED EMBODIMENTS

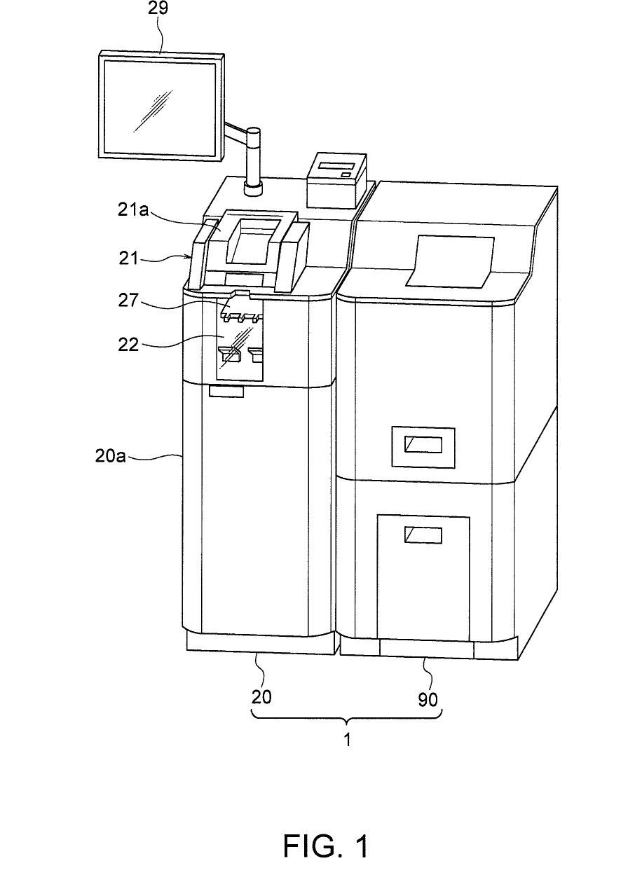

Hereinafter, in an embodiment of a present invention, an example where a banknote handling apparatus for handling banknotes is used as a paper sheet handling apparatus according to the present invention will be described. In addition, in the present embodiment, a money handling machine in which the banknote handling apparatus and a coin handling apparatus are combined is also explained. FIGS. 1 to 10 are diagrams showing the banknote handling apparatus according to the present embodiment and the money handling machine provided with this banknote handling apparatus.

First, a configuration of a money handling machine 1 in the present embodiment will be described with reference to FIG. 1. Generally, a store such as a supermarket is divided into a sales floor and a back office floor. The sales floor is an area where merchandises are displayed and a store clerk performs a deal with a customer who actually purchases merchandises. The back office floor is partitioned from the sales floor and is an area for managing money and merchandises. In the sales floor, one or more money settlement machines (for example, money change machines) are installed. In the back office floor, the money handling machine 1 as shown in FIG. 1 is installed. The money settlement machine is operated by a store clerk, and a settlement process between the store clerk and the customer is performed by the money settling machine. For example, the money settlement machine deposits the money paid by the customer and dispenses a change to be paid to the customer. On the other hand, the money handling machine 1 dispenses a change fund to be replenished to the money settlement machine and deposits sales proceeds collected from the money settlement machine. By using a banknote storage cassette (more specifically, a banknote storage cassette in which a plurality of banknotes are stored and the stored banknotes therein can be fed out) that is detachable to a banknote handling apparatus (not shown) of the money settlement machine and a banknote handling apparatus 20 (to be described later) of the money handling machine 1, the banknotes are delivered between the money settlement machine and the money handling machine 1. When the banknote storage cassette is detached from the banknote handling apparatus (not shown) of the money settlement machine or the banknote handling apparatus 20 (to be described later) of the money handling machine 1, the banknotes stored in the banknote storage cassette can not be taken out.

As shown in FIG. 1, the money handling machine 1 installed in the back office floor includes the banknote handling apparatus 20 and a coin handling apparatus 90. The banknote handling apparatus 20 dispenses the banknotes to be replenished to the money settlement machine installed in the sales floor and deposits the banknotes collected from the money settlement machine. The coin handling apparatus 90 dispenses the coins to be replenished to the money settlement machine installed in the sales floor and deposits the coins collected from the money settlement machine.

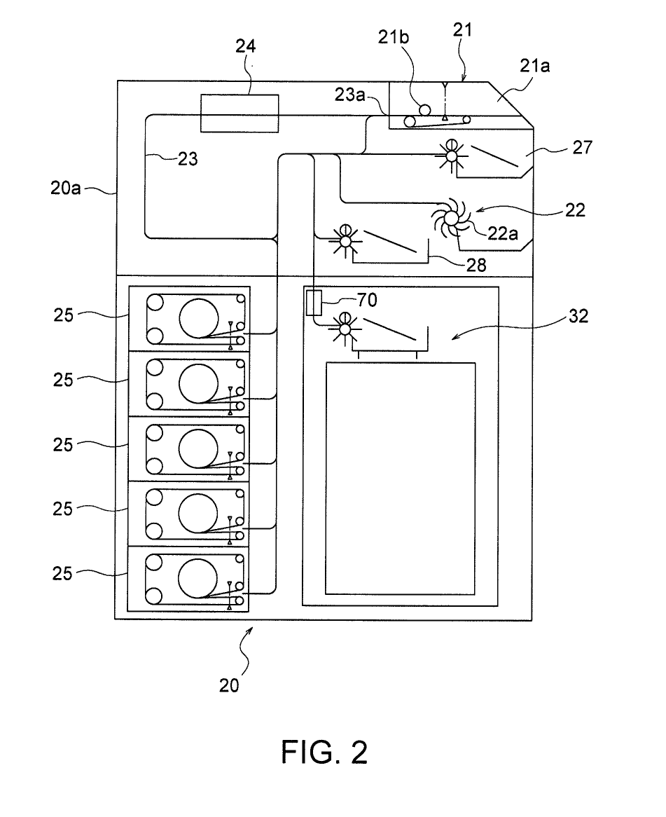

Next, the configuration of the banknote handling apparatus 20 will be described with reference to FIGS. 1 and 2. A side surface on a right side of a housing 20a (to be described later) in FIG. 2 is a front side of the banknote handling apparatus 20 (that is, a front side when the banknote handling apparatus 20 is viewed from the front as shown in FIG. 1), and a left direction in FIG. 2 is a depth direction of the housing 20a.

As shown in FIG. 1, the banknote handling apparatus 20 includes the housing 20a, an inlet unit 21, an ejecting unit 22, and an operation/display unit 29. On the inlet unit 21, a banknote receiving device 21a is detachably mounted. The banknote receiving device 21a receives the banknotes from the outside of the banknote handling apparatus 20 and feeds out the received banknotes into the housing 20a one by one by a banknote feeding mechanism 21b. Such a banknote receiving device 21a is used when an operator (that is, the store clerk) manually deposits the banknotes to the banknote handling apparatus 20. In addition, in place of the banknote receiving device 21a, the banknote storage cassette described above can be mounted on the inlet unit 21. In this case, when the banknote storage cassette is mounted on the inlet unit 21, the banknotes stored in the banknote storage cassette are fed out one by one to the inside of the housing 20a by a feeding mechanism provided inside the banknote storage cassette. The banknotes fed out from storage/feeding units 25 (to be described later) are accumulated in the ejecting unit 22 in a stacked state. The banknotes accumulated in the ejecting unit 22 can be accessed from the outside of the housing 20a.

The operation/display unit 29 displays various information such as a storage condition of the banknotes and coins in the money handling machine 1, and the like. Further, the operation/display unit 29 is configured such that the operator can input data. The operation/display unit 29 is constituted by, for example, a touch-panel-type display and the like. The operation/display unit 29 is provided in either the banknote handling apparatus 20 or the coin handling apparatus 90, and is used in common for displaying information of both the banknote handling apparatus 20 and the coin handling apparatus 90.

As shown in FIG. 2, inside the housing 20a of the banknote handling apparatus 20, there is provided a transporting unit 23 for transporting the banknotes one by one. The above described inlet unit 21 is connected to an end portion 23a of the transporting unit 23. When the banknote receiving device 21a is mounted on the inlet unit 21, the banknotes fed out from the banknote receiving device 21a are transported by the transporting unit 23 via the end portion 23a of the transporting unit 23. As shown in FIG. 2, a recognition unit 24 is provided in the transporting unit 23, and a denomination, fitness, authenticity, and the like of each banknote transported by the transporting unit 23 is recognized by the recognition unit 24. Specifically, the recognition unit 24 includes an image sensor, magnetic sensor, thickness sensor, and the like. The image sensor images the banknotes transported by the transporting unit 23 and the denomination and the like of each of the banknotes is recognized based on each banknote image captured by the image sensor.

As shown in FIG. 2, the banknote handling apparatus 20 is provided with an external rejecting unit 27 and an internal rejecting unit 28, respectively. To the external rejecting unit 27, the banknote recognized as not a normal banknote, of the banknotes put into the housing 20a by the inlet unit 21, is sent from the transporting unit 23 as a reject banknote. The reject banknote is ejected to the outside of the banknote handling apparatus 20 by the external rejecting unit 27. On the other hand, to the internal rejecting unit 28, the reject banknote that can not be ejected to the outside of the banknote handling apparatus 20 is sent from the transporting unit 23 and the reject banknote is stored in the internal rejecting unit 28. An operator such as a store clerk without an administrative authority can not take out the banknotes stored in the internal rejecting unit 28.

A plurality of storage/feeding units 25 is provided inside the housing 20a, and each storage/feeding unit 25 is connected to the transporting unit 23. Each storage/feeding unit 25 stores the banknotes by denomination. More specifically, based on the recognition result by the recognition unit 24, the banknotes fed out from the inlet unit 21 to the transporting unit 23 are sent to each storage/feeding unit 25 by the transporting unit 23 by denomination. In addition, each storage/feeding unit 25 can feed out the banknotes stored therein one by one to the transporting unit 23. More specifically, a winding-type banknote storage/feeding unit is used as each storage/feeding unit 25. The winding-type banknote storage/feeding unit has a substantially cylindrical drum which rotates around a rotation axis, and one end of a strip-shaped winding member for winding a plurality of banknotes one by one is connected to an outer peripheral surface of the drum, for example. When the banknotes are wound on the drum by the strip-shaped winding member, the banknotes are stored in the drum. In addition, as the strip-shaped winding member is rewound from the drum, the stored banknotes are fed out from the drum.

In the banknote handling apparatus 20 according to the present embodiment, a banknote storage mechanism 32 (see FIG. 2) is provided inside the housing 20a. On the banknote storage mechanism 32, a storage bag 34 for storing the banknotes in a stacked state is detachably mountable. The banknotes sent from the storage/feeding unit 25 to the banknote storage mechanism 32 via the transporting unit 23 are stored in the storage bag 34 mounted on the banknote storage mechanism 32 in a stacked state. The storage bag 34 that stores the banknotes in a stacked state is a bag made of polyethylene, for example, and has an opening at a top for taking in and out the banknotes. Further, the storage bag 34 is provided with a plurality of small air-release holes.

Note that the banknotes of denominations not assigned to each storage/feeding unit 25 and the overflow banknotes that can not be stored in each storage/feeding unit 25 because the storage/feeding unit 25 of the corresponding denomination is in a full state are also stored in the storage bag 34. When the storage bag 34 in which the banknotes are stored is taken out from the banknote storage mechanism 32, the banknotes stored in the storage bag 34 are collected from the banknote handling apparatus 20 together with the storage bag 34.

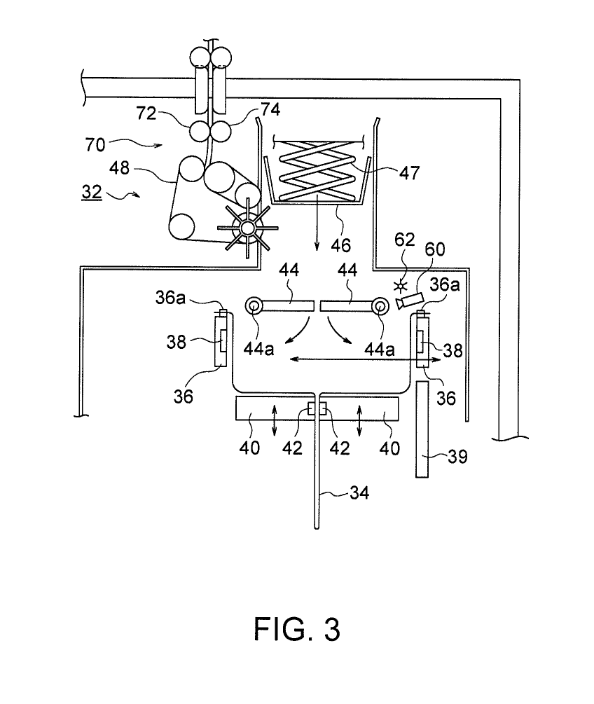

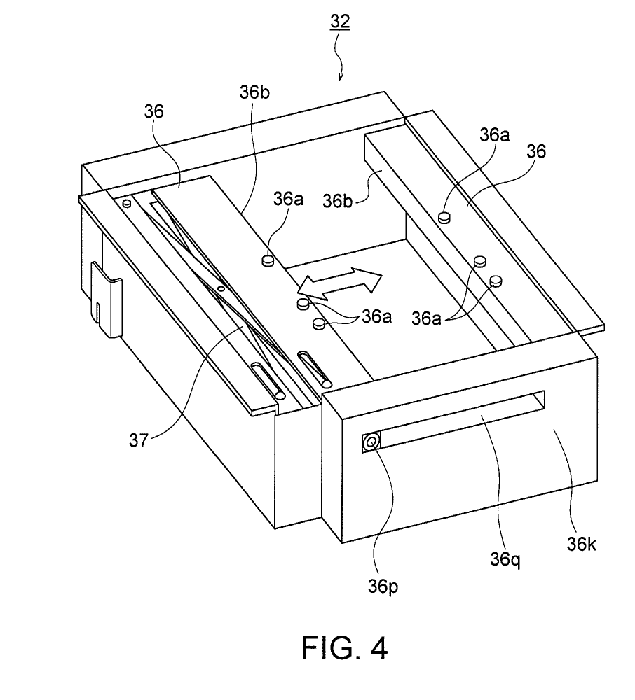

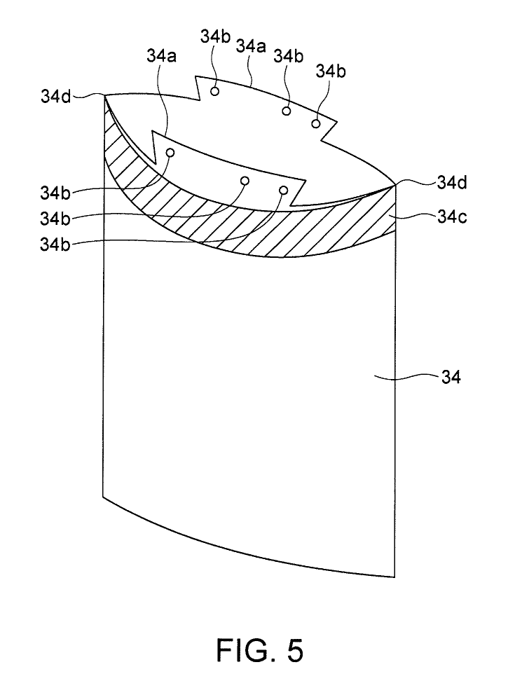

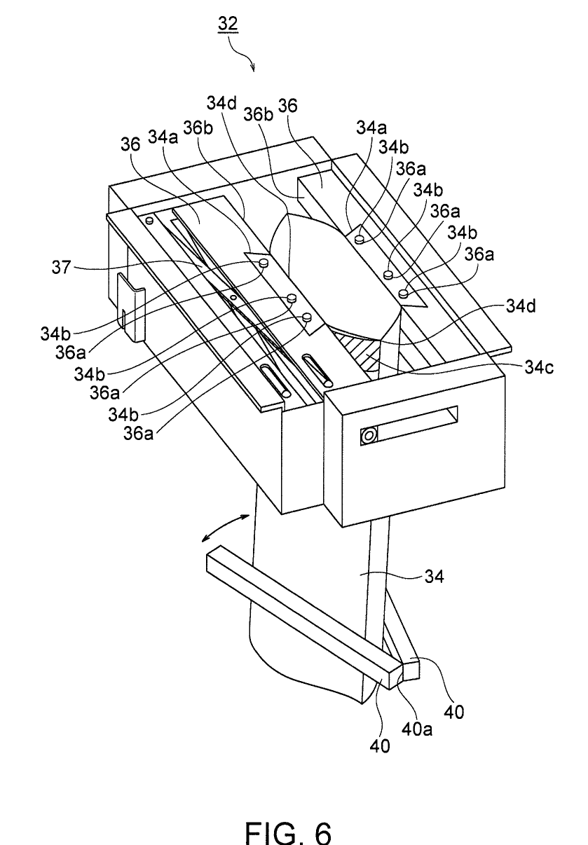

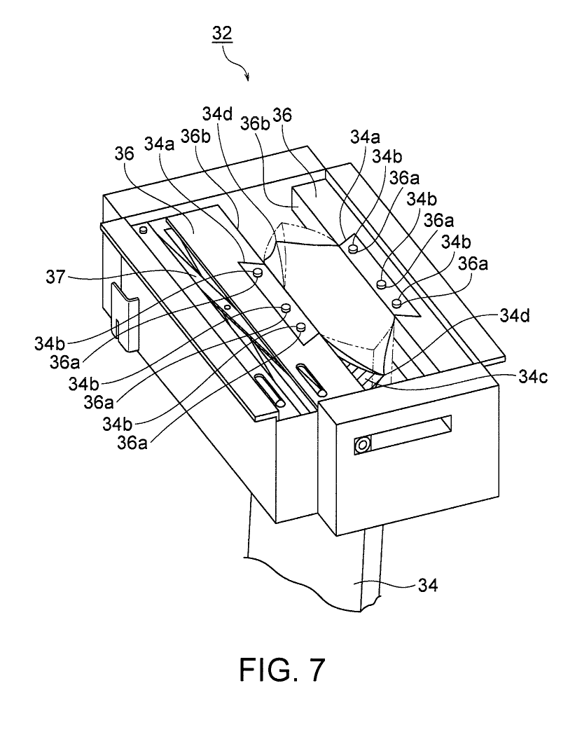

Next, details of the configuration of the banknote storage mechanism 32 in the banknote handling apparatus 20 will be described with reference to FIGS. 3 to 7. FIG. 3 is a side view showing details of the configuration of the banknote storage mechanism 32, FIG. 4 is a perspective view showing a configuration of a pair of holding members 36 and the like in the banknote storage mechanism 32 shown in FIG. 3, and FIG. 5 is a perspective view showing the configuration of the storage bag 34 held by each holding member 36 in the banknote storage mechanism 32 shown in FIG. 3 and the like. FIG. 6 is a perspective view showing a state in which the storage bag 34 is held by each holding member 36 of the banknote storage mechanism 32 shown in FIG. 3 and the like, and FIG. 7 is a perspective view showing a state in which an end portion 34d of the storage bag 34 near the opening thereof hangs down as the banknotes are stored in the storage bag 34 shown in FIG. 6.

As shown in FIGS. 2 and 3, a banknote introducing unit 70 is provided on an inlet side of the banknote storage mechanism 32. More specifically, as shown in FIG. 3, the banknote introducing unit 70 has a pair of rollers 72, 74. The banknotes to be sent from the transporting unit 23 to the banknote storage mechanism 32 are guided to the banknote storage mechanism 32 by passing through a nip formed between the pair of rollers 72, 74. The banknote introducing unit 70 may function as a warp correcting mechanism for correcting a warp of each of the banknotes sent from the transporting unit 23 to the banknote storage mechanism 32. More specifically, a groove portion may be provided near a center of the roller 72 in a width direction thereof, and the roller 74 may be arranged to enter the groove portion of the roller 72. As a result, a part of each of the banknotes passing through the banknote introducing unit 70 can be pushed into the groove of the roller 72 by the roller 74. In this manner, a tendency such as a fold that is different from the warp of the banknote can be applied to the banknote fed out from each storage/feeding unit 25 to the transporting unit 23, and therefore it is possible to correct the warp of banknote.

As shown in FIG. 3, a banknote sending unit 48 is a combination of roller and belt. The banknote sending unit 48 sends the banknotes introduced from the transporting unit 23 by the banknote introducing unit 70 onto a temporary holding unit 44 one by one and then stacks them on the temporary holding unit 44. The temporary holding unit 44 is composed of a pair of left and right, and each temporary holding unit 44 can be rotated downward (that is, in a direction of an arrow in FIG. 3) around an axis 44a provided at the proximal end portion thereof.

As shown in FIG. 3 and the like, in the banknote storage mechanism 32, a pair of holding members 36 is provided so as to be separated from each other and opposed to each other. A portion of the storage bag 34 near the opening thereof is held by each holding member 36. One holding member 36 (specifically, the holding member 36 on the left side in FIG. 3, for example) is fixed in its position, and the other holding member 36 (specifically, the holding member 36 on the right side in FIG. 3, for example) can move toward the position-fixed holding member 36. More specifically, as shown in FIG. 4, a pantograph 37 is provided to one of the pair of right and left holding members 36. One holding member 36 is moved toward the other holding member 36 by the pantograph 37 so that these holding members 36 come into contact with each other. More specifically, a guide pin 36p is provided at an end portion of one holding member 36. A linear long hole 36q for guiding the guide pin 36p is provided on a frame 36k that supports each holding member 36. Note that the long hole 36q is provided so as to extend in a horizontal direction in the frame 36k. When the pantograph 37 extends, the guide pin 36p provided on one holding member 36 is guided along the long hole 36q, whereby this one holding member 36 is moved toward the other holding member 36. As a result, a surface 36b of one holding member 36 comes into contact with a surface 36b of the other holding member 36. In the banknote storage mechanism 32, instead of moving one holding member 36 of the pair of holding members 36 toward the other holding member 36, both holding members 36 may be moved toward the other holding member 36 to a central position so that these holding members 36 come into contact with each other in the central position.

As shown in FIG. 4, three pins 36a are provided on an upper surface of each of the pair of right and left holding members 36. As shown in FIG. 5, a pair of projecting portions 34a each having three openings 34b is provided at a position near the opening of the storage bag 34 (that is, an upper part of the storage bag 34) to be held by each holding member 36. When the storage bag 34 is held by each holding member 36, each pin 36a of each holding member 36 passes through each opening 34b provided in each projecting portion 34a of the storage bag 34. As a result, these projecting portions 34a are held by each holding member 36.

As shown in FIG. 5 and the like, a strip-shaped reinforcing member 34c is provided at a position near the opening of the storage bag 34 on an outer surface thereof. The reinforcing member 34c is formed by polyethylene terephthalate, which is stronger in stiffness than the storage bag 34. With such a reinforcing member 34c, a force to prevent wrinkles from occurring in the storage bag 34 near the opening thereof acts. Here, “strong in stiffness” means that the rigidity against bending is large. Note that, the reinforcing member 34c having weaker in stiffness than the storage bag 34 may be used. Even in this case, reinforcing member 34c as an additional member is provided (attached) on the storage bag 34, the stiffness in the storage bag 34 near the opening thereof is strengthened as a whole and the occurrence of wrinkles in the storage bag 34 near the opening thereof is prevented.

As shown in FIG. 3, each holding member 36 is provided with a heating member 38 (sealing unit). After a predetermined amount of banknotes are stored in the storage bag 34 held by each holding member 36 in the banknote storage mechanism 32, and before the storage bag 34 is taken out from the banknote storage mechanism 32, when one holding member 36 is moved toward the other holding member 36 and these holding members 36 are in contact with each other, heat is applied to a portion of the storage bag 34 near the opening thereof by the heating member 38, whereby the opening of the storage bag 34 is heat-sealed.

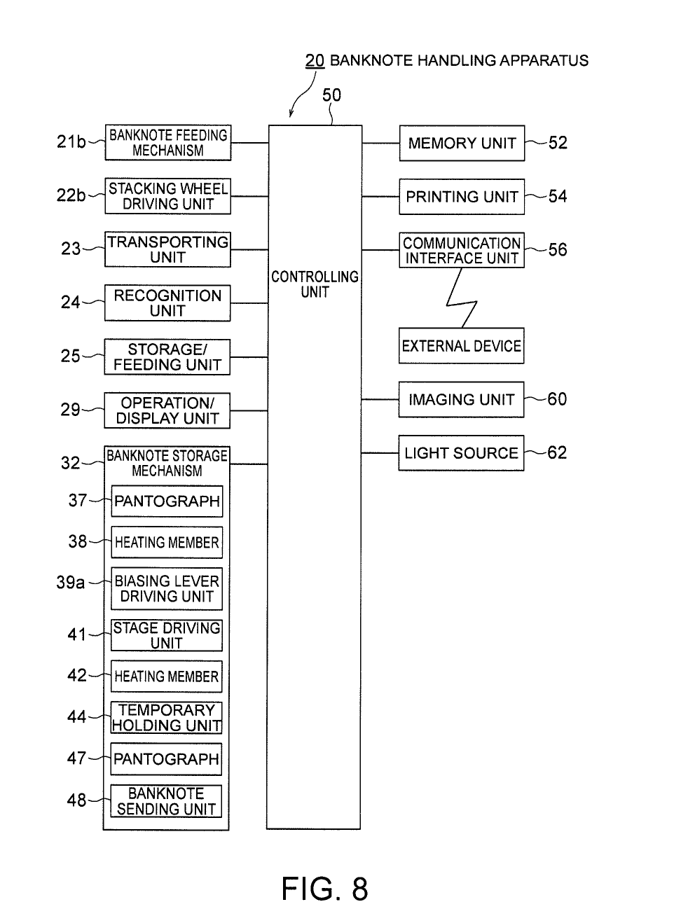

As shown in FIG. 3, in the banknote storage mechanism 32, there is provided a stage 40 on which at least a part of the storage bag 34 held by each holding member 36 is placed. The stage 40 is composed of a pair of right and left, and each stage 40 is movable in the vertical direction and the horizontal direction in FIG. 3. More specifically, as shown in FIG. 6 and the like, the pair of stages 40 are connected to each other by a hinge part 40a provided at an end portion of each stage 40. Each stage 40 can swing in a direction of an arrow in FIG. 6 around the hinge part 40a along a horizontal plane. When each stage 40 opens, a gap is formed between these stages 40. Then, a part of the storage bag 34 held by the holding member 36 can extend downward from each stage 40 through this gap. Each stage 40 is driven by a stage driving unit 41 (see FIG. 8) such as an electric actuator. More specifically, each stage 40 is moved in the vertical direction in FIG. 3 by the stage driving unit 41 and is opened and closed about the hinge part 40a along the horizontal plane. Note that the pair of stages 40 are connected to each other by the hinge part 40a so as to be opened and closed about the hinge part 40a as described above, in FIGS. 3, 9 and 10, for the sake of convenience, opening and closing movements of each stage 40 about the hinge part 40a are indicated by the movement in the lateral direction of each stage 40.

Each stage 40 is provided with a heating member 42 (heat bonding member). Then, before the storage bag 34 is taken out from the banknote storage mechanism 32, when one stage 40 (for example, the stage 40 on the right side in FIG. 3) is moved toward the other stage 40 (for example, the stage 40 on the left side in FIG. 3) and these stages 40 are in contact with each other, heat is applied from each heating member 42 to a portion to be a bottom part of the storage bag 34 when the banknotes are stored therein, so that the bottom portion of the storage bag 34 is thermally bonded and sealed. Note that the position of the storage bag 34 which is thermally bonded and sealed by each heating member 42 varies depending on the storage amount of the banknotes in the storage bag 34.

As shown in FIG. 3, a pusher plate 46 is provided above the pair of temporary holding units 44. The pusher plate 46 is provided with a pantograph 47, and as the pantograph 47 extends downward, the pusher plate 46 can move downward from the state shown in FIG. 3. As the pusher plate 46 moves downward from the state shown in FIG. 3, when the banknotes temporarily held on each temporary holding unit 44 are stored in the storage bag 34, it is possible to push the banknotes remaining on each temporary holding unit 44 toward the storage bag 34 by the pusher plate 46.

As shown in FIG. 3, a biasing lever 39 is provided below the right holding member 36 of the pair of holding members 36. By the biasing lever 39, the banknotes stored in the storage bag 34 held by the pair of holding members 36 can be gathered to one side (specifically, to the left side in FIG. 3) within the storage bag 34. More specifically, the biasing lever 39 can be moved to the left side from the state shown in FIG. 3 by a biasing lever driving unit 39a (see FIG. 8) composed of a pantograph, an electric actuator and the like.

In the banknote storage mechanism 32, in the vicinity of the opening of the storage bag 34 held by the pair of holding members 36, there is provided an imaging unit 60 such as a camera or video camera for imaging the inner surface of the storage bag 34. A mark is provided on an inner surface of the storage bag 34 held by each holding member 36 near the opening of the storage bag 34, and this mark is imaged by the imaging unit 60. In the vicinity of the imaging unit 60, there is provided a light source 62 for irradiating light onto the inner surface of the storage bag 34 held by each holding member 36. By illuminating the inner surface of the storage bag 34 with such a light source 62, the imaging unit 60 can sharply image the mark formed near the opening on the inner surface of the storage bag 34 near the opening thereof.

The banknote handling apparatus 20 according to the present embodiment is provided with a controlling unit 50 for controlling each component of the banknote handling apparatus 20. More specifically, as shown in FIG. 8, to the controlling unit 50, the banknote feeding mechanism 21b provided in the banknote receiving device 21a mounted on the inlet unit 21, a stacking wheel driving unit 22b for driving a stacking wheel 22a provided in the ejecting unit 22, the transporting unit 23, the recognition unit 24, each storage/feeding unit 25, the operation/display unit 29, the banknote storage mechanism 32 (specifically, the pantograph 37, each heating member 38, the biasing lever driving unit 39a, the stage driving unit 41, each heating member 42, each temporary holding unit 44, the pantograph 47 and the banknote sending unit 48), a memory unit 52, a printing unit 54, a communication interface unit 56, the imaging unit 60, the light source 62, and the like are respectively connected. Then, a signal related to a recognition result and detection result of the banknote by the recognition unit 24, and the image taken by the imaging unit 60 are sent to the controlling unit 50. Further, the controlling unit 50 controls the operation of these components by sending a command signal to each component of the banknote handling apparatus 20.

The memory unit 52 stores a process history such as a deposit process of the banknotes in the banknote handling apparatus 20 and an information on the amount of the banknotes stored in each storage/feeding unit 25 and storage bag 34. The printing unit 54 prints on a receipt and the like the process history such as the deposit process of the banknotes in the banknote handling apparatus 20 and the information on the amount of the banknotes stored in each storage/feeding unit 25 and storage bag 34. The controlling unit 50 can transmit and receive signals to and from an external device (specifically, for example, a higher-ranking terminal) provided separately from the banknote handling apparatus 20 according to the present embodiment via the communication interface unit 56. More specifically, the controlling unit 50 can transmit the information stored in the memory unit 52 to the external device provided separately from the banknote handling apparatus 20 via the communication interface unit 56. For example, when a security guard and the like of a security company collects the banknotes together with the storage bag 34, an information on the collected banknotes is transmitted to the computer of the security company and the like by the communication interface unit 56.

Next, in the banknote storage mechanism 32, the operation of storing the banknotes, sent from the transporting unit 23 to the banknote storage mechanism 32, into the storage bag 34 held by the pair of holding members 36 will be briefly described.

The banknotes sent from the transporting unit 23 to the banknote storage mechanism 32 are sent one by one onto the pair of temporary holding units 44 by the banknote sending unit 48 and then accumulated in a stacked state on these temporary holding units 44. When a predetermined number of banknotes are accumulated on the temporary holding units 44, each temporary holding unit 44 rotates downward (that is, in the direction of the arrow in FIG. 3) about the axis 44a provided at the proximal end portion thereof. As a result, the banknotes accumulated on the temporary holding units 44 fall from these temporary holding units 44 due to their own weight and are stored in a stacked state in the storage bag 34. In addition, when the banknotes fall from the temporary holding units 44 and are stored in the storage bag 34, each stage 40 is moved downward by the stage driving unit 41, and then the storage space of the banknotes to be sent from the temporary holding units 44 to the storage bag 34 is formed inside the storage bag 34. A movement amount by which each stage 40 is moved downward by the stage driving unit 41 is determined based on the amount of the banknotes sent from the temporary holding units 44 to the storage bag 34. As a result, the storage space is maintained at a constant size each time. For example, each stage 40 is moved so that a distance between the upper end of the banknotes stored in the storage bag 34 and each heating member 38 provided in each holding member 36 in the vertical direction is 60 mm. In the present embodiment, the controlling unit 50 controls the pantograph 47 such that, when the banknotes are sent into the storage bag 34 held by each holding member 36 and stored in the storage bag 34, the banknotes held onto the temporary holding unit 44 are pushed into the storage bag 34 by the pusher plate 46. As a result, even when the banknotes remain on the temporary holding units 44, such remaining banknotes can be dropped from the temporary holding units 44 and stored in the storage bag 34.

When the banknotes are stored in the storage bag 34 held by each holding member 36, the mark provided on the inner surface of the storage bag 34 near the opening thereof is imaged by the imaging unit 60 each time. When a predetermined amount of the banknotes are stored in the storage bag 34 and the mark is obstructed by the banknotes stored in the storage bag 34 in the image taken by the imaging unit 60 and this mark is no longer captured by the imaging unit 60, the controlling unit 50 determines that the storage state of the banknotes in the storage bag 34 is abnormal. The abnormal storage state is a state in which some banknote is stored in a standing state near the opening of the storage bag 34 or some banknote stored in the storage bag 34 is bent. As described above, since the storage abnormality can be detected based on the image captured by the imaging unit 60, when the holding member 36 on the right side in FIG. 3 moves toward the holding member 36 on the left side and the opening of the storage bag 34 is heat-sealed by the heating member 38 as will be described later, it is possible to inhibit the banknotes stored in the storage bag 34 from being sandwiched between the holding members 36 and causing an unsealed portion to be generated at the opening of the storage bag 34. It should be noted that the abnormal storage state may be determined by the controlling unit 50 based on the pressing operation of the temporary holding unit 44 by the pusher plate 46. More specifically, in the abnormal storage state, some banknotes stored in the storage bag 34 will be present in a movable range of the temporary holding unit 44 (see the arrow in FIG. 3). In this case, when the temporary holding unit 44 is pushed into the storage bag 34 by the pusher plate 46, the end portion of the temporary holding unit 44 comes into contact with the banknotes stored in the storage bag 34. Therefore, it is impossible to push the temporary holding unit 44 further into the storage bag 34 any more. Based on this, it is possible to judge the abnormal storage state occurs. In addition, even in the case where the temporary holding units 44 are provided above the position shown in FIG. 3 and the banknotes stored in the storage bag 34 are not present in the movable range of the temporary holding unit 44, it may be arranged that the abnormal storage state is detected by the controlling unit 50 based on the pushing operation of the pusher plate 46. More specifically, in the abnormal storage state, when pushing the banknotes held on the temporary holding unit 44 into the storage bag 34 by the pusher plate 46, the distance that the pusher plate 46 can move toward the storage bag 34 is shorter than when the storage state is normal. Based on this, it is possible to judge the abnormal storage state occurs.

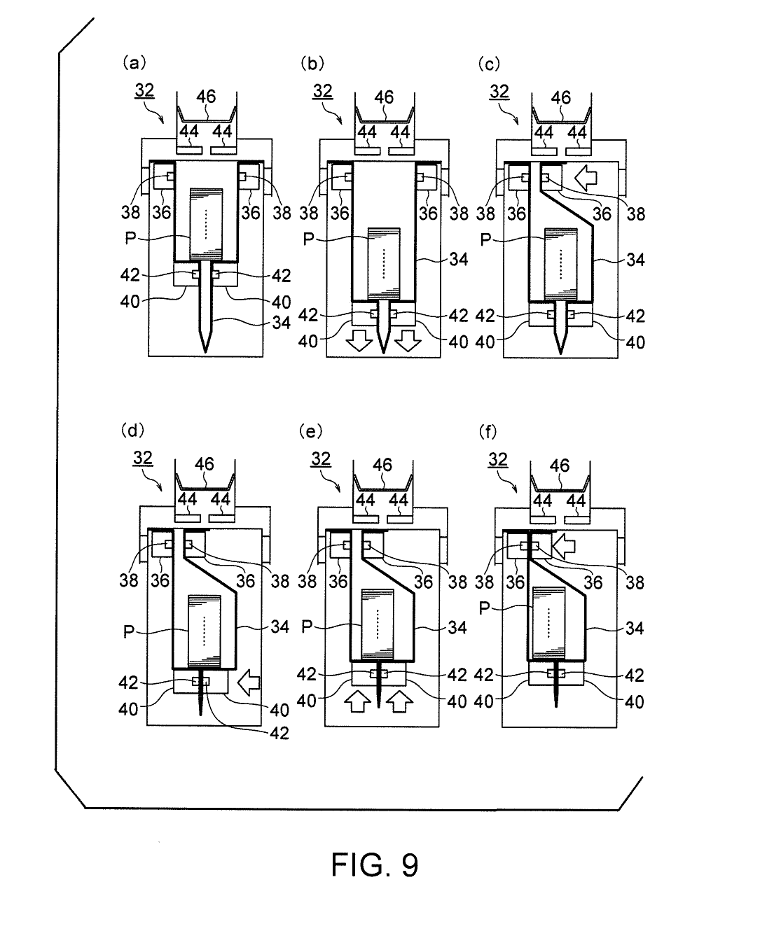

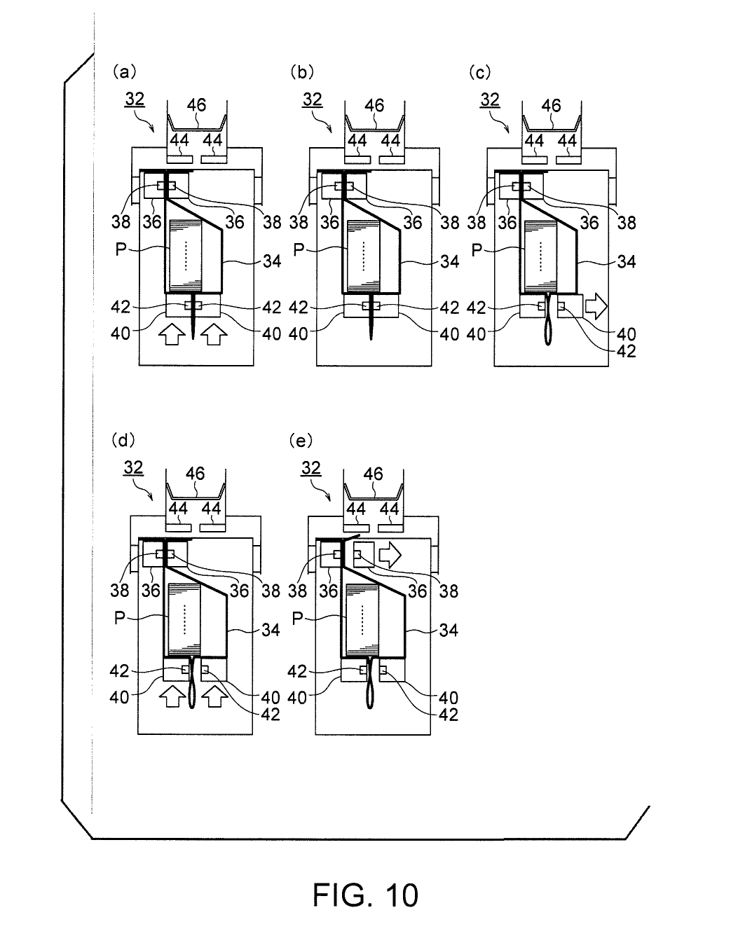

When a sealing process is started, the opening of the storage bag 34 held by each holding member 36 is sealed. The sealing process is started based on an instruction input from the operation/display unit 29. Note that the sealing process may be started based on an instruction input from an external device. Alternatively, the sealing process may be started when the amount of banknotes stored in the storage bag 34 reaches a predetermined amount. The predetermined amount can be a predetermined number of banknotes or a predetermined amount of money. The predetermined number of banknotes may be the number of banknotes in which the storage bag 34 is in a full state or a near-full state. In addition, the sealing process may be started based on the time. When the sealing process is started based on the input instruction or the time, as a process before the sealing process is started, a collecting process such that the banknotes stored in the storage/feeding units 25 are transported to the banknote storage mechanism 32 and stored in the storage bag 34 may be performed. In the collecting process, the banknotes stored in the storage/feeding units 25 may be collected as much as possible. In this case, it is preferable to set an upper limit on the number or amount of banknotes that can be stored in the storage bag 34. Further, the collecting process may be performed such that the number or amount of banknotes stored in the storage bag 34 becomes a predetermined value. Alternatively, in the collecting process, the banknotes of a predetermined number or a predetermined amount may be left in the storage/feeding units 25 and the other banknotes may be collected. After the opening of the storage bag 34 is sealed, the storage bag 34 is taken out from the banknote storage mechanism 32 by the operator's hand. Details of the operation of the sealing process such that the opening of the storage bag 34 held by each holding member 36 is sealed will be described below with reference to FIGS. 9 and 10. The operation of the sealing process as described below is performed by the controlling unit 50 controlling each component of the banknote storage mechanism 32. In FIGS. 9 and 10, the banknotes stored in the storage bag 34 are indicated by reference numeral P.

As shown in FIG. 9 (a), when the sealing process is started, the controlling unit 50 lowers each stage 40 by a predetermined distance by the stage driving unit 41 (see an arrow in FIG. 9 (b)). This makes it possible to make a distance between the upper end of the banknotes stored in the storage bag 34 and each heating member 38 provided in each holding member 36 in the vertical direction larger than a predetermined size. Therefore, when the opening of the storage bag 34 is heat-sealed by each heating member 38 after each holding member 36 approaches and the portion of the storage bag 34 near the opening thereof is sandwiched between the holding members 36, as described later, it is possible to prevent occurrence of an unsealed portion due to the banknotes stored in the storage bag 34 being sandwiched between the holding members 36 and the banknotes being brought into contact with the each heating member 38. For example, before the sealing process is started, the distance between the upper end of the banknotes stored in the storage bag 34 and each heating member 38 provided in each holding member 36 in the vertical direction is 60 mm. When the sealing process is started, the controlling unit 50 lowers each stage 40 by, for example, 40 mm by the stage driving unit 41. As a result, the distance between the upper end of the banknotes stored in the storage bag 34 and each heating member 38 provided in each holding member 36 becomes, for example, 100 mm.

The controlling unit 50 reduces the distance between the holding members 36 to such an extent that the storage bag 34 is not sandwiched between the holding members 36 as shown in FIG. 9 (c), after lowering each stage 40 by the predetermined distance by the stage driving unit 41. Specifically, the holding member 36 on the right side is moved toward the holding member 36 on the left side. Thereafter, as shown in FIG. 9 (d), each stage 40 is moved in the direction of approaching so as to sandwich the portion of the storage bag 34 near the bottom thereof by each stage 40. Specifically, the controlling unit 50 further moves the right stage 40 toward the left stage 40. It should be noted that when the holding member 36 on the right side is moved toward the holding member 36 on the left side so that the distance between the holding members 36 becomes small, instead of bringing each holding member 36 into contact with each other, a slight gap is formed between each holding member 36. Then, as shown in FIG. 9 (e), the stage driving unit 41 raises each stage 40 by a predetermined distance. The distance to raise each stage 40 is smaller than the distance in which each stage 40 is lowered (see FIG. 9 (b)). For example, the distance to raise each stage 40 is 10 mm. Thereby, the tension in the vertical direction applied to the storage bag 34 can be reduced. Thereafter, as shown in FIG. 9 (f), by further moving each holding member 36 to the direction of approaching, a portion of the storage bag 34 near the opening thereof is sandwiched by each holding member 36. Specifically, the holding member 36 on the right side is further moved in the direction of approaching the holding member 36 on the left side. The biasing lever 39 may also be moved to the left in FIG. 3 by the biasing lever driving unit 39a. As a result, the banknotes stored in the storage bag 34 are brought to one side (concretely, the left side) from the outside of the storage bag 34 by the biasing lever 39. Before raising each stage 40 by the predetermined distance, by moving the holding member 36 so that the distance between the holding members 36 becomes small as shown in FIG. 9 (c), the tension of the opening portion of the storage bag 34 can be reduced. Thereby, when the stage 40 is raised by the predetermined distance, the state in which the end portion 34d of the storage bag 34 hangs down is easily corrected. Further, since the distance between the holding members 36 is reduced, it is possible to prevent the banknotes from jumping out from the opening of the storage bag 34 when each stage 40 is raised. Further, before the holding members 36 hold the portion of the storage bag 34 near the opening thereof, the opening of the storage bag 34 is in a free state to some extent. Therefore, it is possible to reliably correct the state in which the end portion 34d of the storage bag 34 hangs down when each stage 40 is raised by the predetermined distance.

The state when the end portion 34d of the storage bag 34 hangs down will be described with reference to FIG. 7. In FIG. 7, the state when the end portion 34d of the storage bag 34 does not hang is indicated by a two-dot chain line, and the state when the end portion 34d of the storage bag 34 hangs down is indicated by a solid line. By storing the banknotes in the storage bag 34, the weight of the banknotes stored in the storage bag 34 is loaded to the portion of the storage bag 34 near the opening thereof. Therefore, there is a possibility that the both end portions 34d of the storage bag 34 may hang down. If the end portion 34d of the storage bag 34 hangs down as described above, there is a problem that sealing failure occurs when the opening of the storage bag 34 is heat-sealed by each heating member 38. In contrast, in the present embodiment, before raising each stage 40 by the predetermined distance, as shown in FIG. 9 (c), the holding member 36 on the right side is moved toward the holding member 36 on the left side such that the distance between the holding members 36 becomes small to the extent that the storage bag 34 is not sandwiched between the holding members 36, and each stage 40 is raised by the predetermined distance as shown in FIG. 9 (e) before the portion of the storage bag 34 near the opening thereof is sandwiched between the holding members 36. These matters make it possible to prevent the hanging down of the end portion 34d of the storage bag 34.

The controlling unit 50 moves the holding member 36 on the right side in the direction of approaching the holding member 36 on the left side as shown in FIG. 9 (f), so that the portion of the storage bag 34 near the opening thereof is sandwiched by each holding member 36. Specifically, the holding member 36 on the right side is further moved in the direction of approaching the holding member 36 on the left side. Thereafter, the controlling unit 50 raises each stage 40 further by a predetermined distance by the stage driving unit 41 as shown in FIG. 10 (a). The distance to raise each stage 40 is smaller than the distance to lower each stage 40 earlier (see FIG. 9 (b)). For example, the distance to raise each stage 40 is 10 mm. Then, in the state shown in FIG. 10 (b), the opening of the storage bag 34 is heat-sealed by each heating member 38. Thereafter, the portion to be the bottom part of the storage bag 34 when the banknotes are stored therein is heat-sealed by each heating member 42. As shown in FIG. 9 (f), in a state in which the portion of the storage bag 34 near the opening thereof is sandwiched between the holding members 36, the tension applied to the storage bag 34 may not be completely removed in some cases. Further, when the holding member 36 on the right side is moved toward the holding member 36 on the left side, the tension applied to the storage bag 34 is increased, so that there is a fear that the opening of the storage bag 34 is not properly heat-sealed by each heating member 38. However, in the present embodiment, after the portion of the storage bag 34 near the opening thereof is sandwiched between the holding members 36, by further raising each stage 40 by the predetermined distance by the stage driving unit 41, the tension applied to the storage bag 34 can be relaxed or removed. Further, in the present embodiment, after the opening of the storage bag 34 is heat-sealed by each heating member 38, the portion to be the bottom part of the storage bag 34 when the banknotes are stored therein is thermally bonded and sealed by each heating member 42. Therefore, even if some trouble occurs during the sealing process and the sealing process is interrupted, it is possible to prevent the banknotes from being taken out by malicious operators from the storage bag 34 because the opening of the storage bag 34 is heat-sealed in advance.

Next, the controlling unit 50 moves each stage 40 by the stage driving unit 41 so that the stages 40 are separated from each other as shown in FIG. 10 (c). Specifically, the right stage 40 is moved in a direction away from the left stage 40. Thereafter, the controlling unit 50 raises each stage 40 further by the stage driving unit 41 as shown in FIG. 10 (d). A distance to raise each stage 40 is smaller than the distance to lower each stage 40 in advance (see FIG. 9 (b)). For example, the distance to raise each stage 40 is 10 mm. As shown in FIGS. 9 (e), 10 (a), and 10 (d), the controlling unit 50 raises each stage 40 by a plurality of steps in the sealing process. The sum of the distances to raise each stage 40 is smaller than the distance to lower each stage 40 in advance (see FIG. 9 (b)). For example, the total distance to raise each stage 40 is 30 mm. After the opening of the storage bag 34 is heat-sealed by each heating member 38, by raising each stage 40, extra air inside the storage bag 34 can be removed. Therefore, the volume of the storage bag 34 can be reduced. After the storage bag 34 is taken out from the banknote storage mechanism 32 as will be described later, for example, the storage bag 34 is bound by a band and the like by the operator. If the extra air inside the storage bag 34 is removed and the volume of the storage bag 34 is reduced, it is possible to easily bind the storage bag 34 with the band and the like.

Then, after raising each stage 40 as shown in FIG. 10 (d), the controlling unit 50 moves each holding member 36 so that each holding member 36 is separated as shown in FIG. 10 (e). Specifically, the holding member 36 on the right side is moved away from the holding member 36 on the left side. Thereafter, by removing the storage bag 34 from each holding member 36, the storage bag 34 can be taken out from the upper side of each holding member 36 of the banknote storage mechanism 32 in the upward direction.

As described above, according to the banknote handling apparatus 20 of the present embodiment, when the sealing process for sealing the opening of the storage bag 34 held by each holding member 36 is performed, each stage 40 on which at least a part of the storage bag 34 held by each holding member 36 is placed is raised. This makes it possible to reduce the distance between the upper end of the storage bag 34 held by each holding member 36 and the portion to be the bottom part of the storage bag 34 when storing the paper sheets are stored therein in the vertical direction, whereby the sealing process can be properly performed. More specifically, each stage 40 is raised by the predetermined distance before the portion of the storage bag 34 near the opening thereof is sandwiched by each holding member 36. In addition, after holding the portion of the storage bag 34 near the opening thereof by each holding member 36, each stage 40 is raised further by the predetermined distance. As a result, the tension applied to the storage bag 34 can be relaxed. In addition, it is possible to prevent the end portion 34d of the storage bag 34 from hanging down. Therefore, the opening of the storage bag 34 can be properly heat-sealed by each heating member 38. Further, after the opening of the storage bag 34 is heat-sealed by each heating member 38, it becomes possible to remove the extra air inside the storage bag 34 by raising each stage 40, whereby the volume of the storage bag 34 can be reduced.

Note that the banknote handling apparatus 20 and the banknote handling method (Specifically, the method of the sealing process for sealing the opening of the storage bag 34 held by each holding member 36) according to the present embodiment are not limited to the above-described aspects, and various modifications can be made.

For example, in a banknote handling apparatus according to a modified example, a cylindrical storage bag having openings at its upper and lower ends, respectively, is held by a holding unit, and the banknotes are stored in the cylindrical storage bag held by the holding unit. Even in this case, a principle of the present invention can be applied to the banknote handling apparatus according to the modified example described above.

In another aspect of the present embodiment, instead of heat-sealing the opening of the storage bag with a heating member, the opening of the storage bag may be bonded by a bonding material and sealed. Specifically, as the storage bag in which the banknotes are stored, one in which the bonding material is provided in the opening on the inner surface thereof may be used. In this case, by bonding the opening of the storage bag with the bonding material, the opening of the storage bag can be sealed.

In the method of the sealing process as shown in FIGS. 9 and 10, the stage 40 is raised by three steps (see FIGS. 9 (e), 10 (a) and 10 (d)) before and after the opening of the storage bag 34 held by each holding member 36 is sealed by each heating member 38. However, the present embodiment is not limited to such an aspect. In another aspect of the present embodiment, the raising operation of the stage 40 by at least one step or two steps of three steps corresponding to FIGS. 9 (e), 10 (a) and 10 (d) may be performed. More specifically, for example, the raising operation of the stage 40 as shown in FIG. 10 (d) is omitted, and the raising operation of the stage 40 may be performed by two steps as shown in FIGS. 9 (e) and 10 (a), before sealing the opening of the storage bag 34 held by each holding member 36 with each heating member 38. In yet another example, only one of the raising operation of the stage 40 as shown in FIG. 9 (e) and the raising operation of the stage 40 as shown in FIG. 10 (a) may be performed before the opening of the storage bag 34 held by each holding member 36 is sealed by each heating member 38.

Further, in another aspect of the present embodiment, the operation as shown in FIG. 9 (c) may be omitted. That is, after lowering each stage 40 as shown in FIG. 9 (b), by moving the holding member 36 on the right side toward the holding member 36 on the left side, the portion of the storage bag 34 near the opening thereof may be sandwiched by each holding member 36, and thereafter each stage 40 may be raised. Even in this case, by raising each stage 40 before sealing the portion of the storage bag 34 held by each holding member 36 near the opening thereof, it is possible to relax the tension applied to the storage bag 34. Therefore, each heating member 38 can properly heat-seal the portion of the storage bag 34 near the opening thereof.

In another aspect of the present embodiment, a heating member for thermally bonding and sealing the opening of the storage bag 34 may be different from each holding member 36. Further, in still another aspect of the present embodiment, a heat bonding member for thermally bonding and sealing the portion to be the bottom part of the storage bag 34 when the banknotes are stored therein may be different from each stage 40. Further, in still another aspect of the present embodiment, it is not necessary to seal the portion to be the bottom part of the storage bag 34 when the banknotes are stored therein. In this case, the heating member is not provided in each stage 40 and the like. In still another aspect of the present embodiment, instead of storing the banknotes in the storage bag 34 in a stacked state, the banknotes may be stored in an arbitrary posture. For example, the banknotes may be dropped one by one from the opening of the storage bag 34 to the inside.

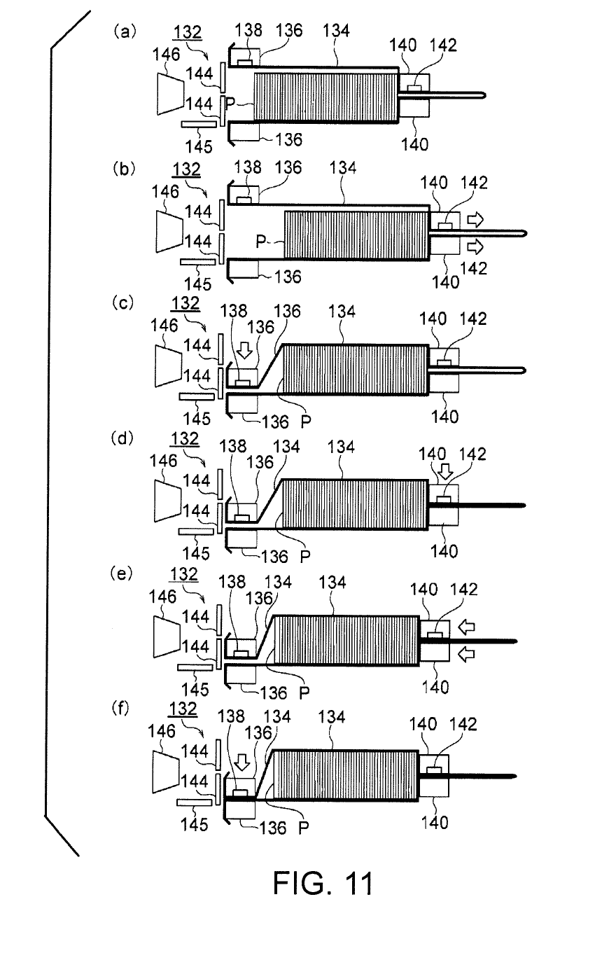

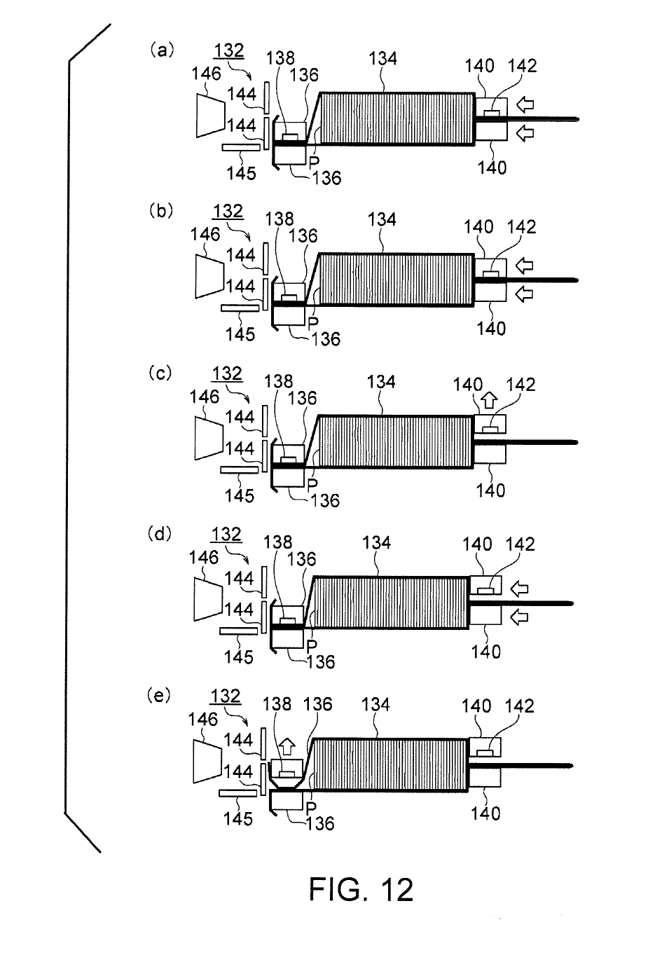

Further, as a banknote storage mechanism for storing the banknotes inside the storage bag, it may be used other than the aspect in which the banknotes are stacked in the storage bag such that the banknotes are aligned along the vertical direction as shown in FIG. 3 and the like. For example, in a banknote storage mechanism according to a modified example, the banknotes may be stacked inside the storage bag such that the banknotes are aligned along the horizontal direction. Such a banknote storage mechanism and an operation of sealing the opening of the storage bag in which the banknotes are stored in the banknote storage mechanism will be described with reference to FIGS. 11 and 12.

As shown in FIG. 11 and the like, in a banknote storage mechanism 132 according to the modified example, a pair of holding members 136 is provided so as to be vertically separated from each other and opposed to each other. A portion of a storage bag 134 near an opening thereof is held by each holding member 136. One holding member 136 (specifically, for example, the lower holding member 136 in FIG. 11 and the like) is fixed in its position, and the other holding member 136 (specifically, the upper holding member 136 in FIG. 11 and the like, for example) can move toward the position-fixed one holding member 136. Then, as the upper holding member 136 moves toward the lower holding member 136, these holding members 136 are in contact with each other. The upper holding member 136 is provided with a heating member 138 (sealing unit). After a predetermined amount of banknotes are stored in the storage bag 134 held by each holding member 136 in the banknote storage mechanism 132, before the storage bag 134 is taken out from the banknote storage mechanism 132, when the upper holding member 136 moves toward the lower holding member 136 and these holding members 136 are in contact with each other, heat is applied to the portion of the storage bag 134 near the opening thereof by the heating member 138, whereby the opening of the storage bag 134 is heat-sealed. Note that, in FIG. 11 and the like, an example in which the heating member 138 is provided in the upper holding member 136 is shown, but the heating members 138 may be provided in the upper holding member 136 and the lower holding member 136 respectively.

As shown in FIG. 11 and the like, in the banknote storage mechanism 132, a pair of upper and lower stages 140 is provided near a bottom of the storage bag 134 held by each holding member 136. Each stage 140 is movable in the vertical direction and the horizontal direction in FIG. 11 and the like, respectively. Further, when the stages 140 are separated from each other, a part of the storage bag 134 held by each holding member 136 can be made to extend rightward from each stage 140 through a gap between the stages 140. Note that each stage 140 is driven by a stage driving unit (not shown) such as an electric actuator. Specifically, the upper stage 140 is moved in the vertical direction in FIG. 11 and the like with respect to the lower stage 140 and each stage 140 is moved in the lateral direction in FIG. 11 and the like by the stage driving unit. In addition, the upper stage 140 is provided with a heating member 142 (heat bonding member). Then, before the storage bag 134 is taken out from the banknote storage mechanism 132, when the upper stage 140 moves toward the lower stage 140 and these stages 140 are in contact with each other, heat is applied to the portion to be the bottom part of the storage bag 134 when the banknotes are stored therein from the heating member 142, whereby the bottom portion of the storage bag 134 is thermally bonded and sealed. The portion of the storage bag 134 thermally bonded by the heating member 142 varies depending on the storage amount of the banknotes in the storage bag 134. Note that, in FIG. 11 and the like, an example in which the heating member 142 is provided in the upper stage 140 is shown, but the heating members 142 may be provided in the upper stage 140 and the lower stage 140 respectively.

As shown in FIG. 11 and the like, in the banknote storage mechanism 132, a pair of upper and lower temporary holding units 144 for temporarily holding the banknotes before being stored in the storage bag 134 held by each holding member 136, and a placement table 145 on which the banknotes held by each temporary holding unit 144 are placed in an standing state are respectively provided. Of the pair of upper and lower temporary holding units 144, the temporary holding unit 144 on the upper side can rotate toward the inner side of the storage bag 134 (that is, on the right side in FIG. 11 and the like) around an axis provided at an upper end portion of the temporary holding unit 144. In addition, the temporary holding unit 144 on the lower side can rotate toward the inner side of the storage bag 134 (that is, on the right side in FIG. 11 and the like) around an axis provided at a lower end portion of the temporary holding unit 144. In the placement table 145, the banknotes on the left side of each temporary holding unit 144 in FIG. 11 and the like (that is, the banknotes before being stored in the storage bag 134 held by each holding member 136) are placed in a standing state. As shown in FIG. 11 and the like, a pusher plate 146 is provided to the left side of the pair of temporary holding units 144. A pantograph (not shown) is provided at the left end portion of the pusher plate 146, and by extending this pantograph to the right, the pusher plate 146 can move rightward from the state shown in FIG. 11 and the like. When such a pusher plate 146 moves rightward from the state shown in FIG. 11 and the like, the banknotes temporarily held in each temporary holding unit 144 (that is, the banknotes placed in a standing state on the placement table 145) are pushed toward the inside of the storage bag 134, and whereby the pushed banknotes are stored in the storage bag 134. In the banknote storage mechanism 132 shown in FIG. 11 and the like, a controlling unit (not shown) for controlling each component of the banknote storage mechanism 132 is provided.

Next, in the banknote storage mechanism 132 shown in FIGS. 11 and 12, the operation of storing the banknotes in the storage bag 134 held by the pair of holding members 136 will be briefly described.

The banknotes sent to the banknote storage mechanism 132 from the outside thereof are placed on the placement table 145 in a standing state on the left side of the pair of upper and lower temporary holding units 144. When a predetermined number of banknotes are placed on the placement table 145 in a standing state, the pantograph provided on the pusher plate 146 extends rightward in FIG. 11 and the like, whereby the pusher plate 146 moves rightward from the state shown in FIG. 11 and the like. As a result, each temporary holding unit 144 rotates toward the right side in FIG. 11 and the like around the axis provided at the proximal end portion thereof, and the banknotes placed in a standing state on the placement table 145 are pushed toward the inside of the storage bag 134 by the pusher plate 146 and then stored in the storage bag 134. As the banknotes are pushed toward the inside of the storage bag 134 by the pusher plate 146, the opening of the storage bag 134 held by the pair of holding members 136 is subjected to a tension in the direction of storing the banknotes.

Then, when the sealing process is started, the opening of the storage bag 134 held by each holding member 136 is sealed. The operation and condition for starting the sealing process are the same as those in which the banknotes are stacked in the storage bag 34 so as to align along the vertical direction as shown in FIG. 3 and the like. Further, after the opening of the storage bag 134 is sealed, the storage bag 134 is taken out from the banknote storage mechanism 132 by the operator's hand. Details of the operation of the sealing process for sealing the opening of the storage bag 134 held by each holding member 136 will be described below with reference to FIGS. 11 and 12. In FIGS. 11 and 12, the banknotes stored in the storage bag 134 are indicated by reference symbol P.

As shown in FIG. 11 (a), when the sealing process is started, each stage 140 is moved by the stage driving unit (not shown) by a predetermined distance in a direction away from each holding member 136 (that is, to the right in FIG. 11 and the like) (See an arrow in FIG. 11 (b)). Further, after each stage 140 is moved, the banknotes stored in the storage bag 134 are further pushed into the storage bag 134 by the pusher plate 146. This makes it possible to set a distance between the left end portion of the banknotes stored in the storage bag 134 and the heating member 138 provided in the holding member 136 in the lateral direction of FIG. 11 and the like to a predetermined size or more. Therefore, when the opening of the storage bag 134 is heat-sealed by the heating member 138 after the holding members 136 come close to each other and a portion of the storage bag 134 near the opening thereof is sandwiched between the holding members 136 as described later, it is possible to prevent occurrence of an unsealed portion due to the banknotes stored in the storage bag 134 being sandwiched between the holding members 136 and contacting with the heating member 138.

The controlling unit (not shown) moves each stage 140 by the predetermined distance away from each holding member 136 (that is, to the right in FIG. 11 and the like). Thereafter, as shown in FIG. 11 (c), the distance between the holding members 136 is reduced to such an extent that the storage bag 134 is not sandwiched between the holding members 136. Specifically, the upper holding member 136 is moved toward the lower holding member 136. Thereafter, as shown in FIG. 11 (d), each stage 140 is moved in an approaching direction, and the portion of the storage bag 134 near the bottom thereof is sandwiched between the stages 140. Specifically, the upper stage 140 is moved in a direction of approaching the lower stage 140 (that is, downward in FIG. 11 and the like). It should be noted that when the upper holding member 136 is moved toward the lower holding member 136 so that the distance between the holding members 136 becomes small, instead of bringing the holding members 136 into contact with each other, a slight gap is formed between each holding member 136. Then, as shown in FIG. 11 (e), each stage 140 is moved by the stage driving unit (not shown) by a predetermined distance in a direction of approaching each holding member 136. As a result, the tension applied to the opening of the storage bag 134 can be reduced. Thereafter, as shown in FIG. 11 (f), each holding member 136 is moved in the approaching direction, so that the portion of the storage bag 134 near the opening thereof is sandwiched between the holding members 136. Specifically, the upper holding member 136 is further moved toward the lower holding member 136.

The controlling unit moves the upper holding member 136 and the lower holding member 136 toward each other as shown in FIG. 11 (f) so that the portion of the storage bag 134 near the opening thereof is sandwiched by each holding member 136. Specifically, the upper holding member 136 is further moved toward the lower holding member 136. Thereafter, as shown in FIG. 12 (a), each stage 140 is further moved by the stage driving unit (not shown) by a predetermined distance further in the direction of approaching each holding member 136 (that is, to the left in FIG. 12). This further reduces the tension applied to the opening of the storage bag 134. Then, in the state as shown in FIG. 12 (b), the opening of the storage bag 134 is heat-sealed by the heating member 138, and thereafter, the portion to be the bottom part of the storage bag 134 when the banknotes are stored therein is thermally bonded and sealed by the heating member 142. Note that, in a state where the portion of the storage bag 134 near the opening thereof is sandwiched between the holding members 136 as shown in FIG. 11 (f), the tension applied to the storage bag 134 may not be completely removed in some cases. In addition, when the holding member 136 on the upper side is moved toward the holding member 136 on the lower side, the tension applied to the storage bag 134 is increased and there is a possibility that the opening of the storage bag 134 can not be properly heat-sealed by the heating member 138. However, in the example shown in FIGS. 11 and 12, after holding the portion of the storage bag 134 near the opening thereof by each holding member 136, each stage 140 is further moved by the predetermined distance in the direction of approaching each holding member 136. This makes it possible to relax or remove the tension on the storage bag 134. Further, after the opening of the storage bag 134 is heat-sealed by the heating member 138, the portion to be the bottom part of the storage bag 134 when the banknotes are stored therein is thermally bonded and sealed by the heating member 142. Therefore, even if some trouble occurs during the sealing process and the sealing process is interrupted, by heat-sealing the opening of the storage bag 134 in advance, it is possible to prevent the malicious operator from taking out the banknotes from the storage bag 134.

Next, the controlling unit moves each stage 140 by the stage driving unit (not shown) so that the stages 140 are separated from each other as shown in FIG. 12 (c). More specifically, the upper stage 140 is moved away from the lower stage 140. Thereafter, each stage 140 is further moved in a direction of approaching each holding member 136 (that is, to the left in FIG. 12) by the stage driving unit as shown in FIG. 12 (d). After the opening of the storage bag 134 is heat-sealed by the heating member 138, by moving each stage 140 in a direction of approaching each holding member 136, extra air inside the storage bag 134 can be removed. This makes it possible to reduce the volume of the storage bag 134.

Thereafter, the controlling unit moves each stage 140 in a direction of approaching each holding member 136 as shown in FIG. 12 (d), and then moves each holding member 136 so as to be separated as shown in FIG. 12 (e). Specifically, the upper holding member 136 is moved away from the lower holding member 136. Thereafter, by removing the storage bag 134 from each holding member 136, the storage bag 134 can be taken out to the left from the left side of each holding member 136 of the banknote storage mechanism 132.

As described above, according to the banknote handling apparatus provided with the banknote storage mechanism 132 of the modified example as shown in FIG. 11 and the like, when the sealing process for sealing the opening of the storage bag 134 held by each holding member 136 is performed, each stage 140 on which at least a part of the storage bag 134 held by each holding member 136 is faced is moved in the direction of approaching each holding member 136. This makes it possible to reduce the distance between the upper end portion of the storage bag 134 held by each holding member 136 and the portion in the storage bag 134 that faces each stage 140 in the lateral direction in FIG. 11 and the like (that is, the stacking direction of the banknotes inside the storage bag 134), whereby the sealing process can be properly performed. More specifically, each stage 140 is further moved in the direction of approaching each holding member 136 by the predetermined distance, after the portion of the storage bag 134 near the opening thereof is sandwiched by each holding member 136. This makes it possible to relax the tension applied to the storage bag 134, so that the opening of the storage bag 134 can be properly heat-sealed by the heating member 138. Further, after the opening of the storage bag 134 is heat-sealed by each heating member 138, it becomes possible to remove the extra air inside the storage bag 134 by moving each stage 140 toward each holding member 136, whereby the volume of the storage bag 134 can be reduced.

Further, in the above description, the example in which the storage bag is detachably mounted on the banknote handling apparatus 20 of the money handling machine 1 installed in the back office floor has been described, but the present invention is not limited to this aspect. For example, the principle of the present invention may be applied to a banknote handling apparatus of a cash settlement apparatus installed in a sales floor.

In addition, the paper sheet handling apparatus according to the present invention may handle paper sheets other than the banknotes (for example, checks, gift certificates, and the like). In other words, the principle of the present invention may also be applied to a case where the banknote storage mechanism 32 as shown in FIG. 3 and the like handles the paper sheets other than the banknotes. Even in this case, when the sealing process is performed to seal the opening of the storage bag 34 held by the holding unit (for example, each holding member 36), after lowering the placement unit (each stage 40) on which at least a part of the storage bag 34 held by the holding unit is placed, the placement unit is raised. This makes it possible to reduce the distance between the upper end of the storage bag 34 held by the holding unit and the portion of the storage bag 34 placed on the placement unit in the vertical direction, and therefore the sealing process can be properly performed.

What is claimed is:

1. A paper sheet handling apparatus for storing a paper sheet inside a storage bag provided with an opening comprising:
a holding unit which holds a portion of the storage bag near the opening thereof;
a sealing unit which seals the opening of the storage bag held by the holding unit;
a placement unit that is movable in a substantially vertical direction and on which at least a part of the storage bag held by the holding unit is placed;
a driving unit which moves the placement unit in the substantially vertical direction; and
a control unit which controls the driving unit such that when a sealing process for sealing the opening of the storage bag held by the holding unit with the sealing unit is performed, the placement unit on which at least a part of the storage bag held by the holding unit is placed is raised.

2. The paper sheet handling apparatus according to claim 1, wherein the control unit controls the driving unit such that the placement unit is raised before the opening of the storage bag held by the holding unit is sealed by the sealing unit.

3. The paper sheet handling apparatus according to claim 2, wherein
the holding unit includes a pair of holding members, at least one of the holding members is movable in a direction toward and away from the other holding member, and the storage bag is sandwiched between the holding members when the holding members approach,
the sealing unit seals the opening of the storage bag sandwiched between the holding members, and
the control unit controls the driving unit such that the placement unit on which at least a part of the storage bag held by the holding unit is placed is raised before sandwiching the storage bag between the holding members.

4. The paper sheet handling apparatus according to claim 3, wherein
the placement unit includes a pair of placement members, at least one of the placement members is movable in a direction toward and away from the other placement member, and the storage bag is sandwiched between the placement members when the placement members approach, and
the control unit controls the driving unit such that the placement unit on which at least a part of the storage bag held by the holding unit is placed is raised after sandwiching the storage bag between the placement members.

5. The paper sheet handling apparatus according to claim 3, wherein
the control unit controls the driving unit such that at least one of the holding members is moved in a direction of approaching the other holding member so that a distance between the holding members is reduced to such an extent that the storage bag is not sandwiched between the holding members, and thereafter the placement unit is raised.

6. The paper sheet handling apparatus according to claim 2, wherein
the holding unit includes a pair of holding members, at least one of the holding members is movable in a direction toward and away from the other holding member, and the storage bag is sandwiched between the holding members when the holding members approach,
the sealing unit seals the opening of the storage bag sandwiched between the holding members, and
the control unit controls the driving unit such that the placement unit on which at least a part of the storage bag held by the holding unit is placed is raised after sandwiching the storage bag between the holding members.

7. The paper sheet handling apparatus according to claim 6, wherein
the control unit controls the driving unit such that the placement unit on which at least a part of the storage bag held by the holding unit is placed is raised before sandwiching the storage bag between the holding members, thereafter sandwiching the storage bag between the holding members, and then the placement unit is further raised after sandwiching the storage bag between the holding members.

8. The paper sheet handling apparatus according to claim 1, wherein
the control unit controls the driving unit such that the placement unit is raised after the opening of the storage bag held by the holding unit is sealed by the sealing unit.

9. The paper sheet handling apparatus according to claim 8, wherein
the placement unit includes a pair of placement members, at least one of the placement members is movable in a direction toward and away from the other placement member, and the storage bag is sandwiched between the placement members when the placement members approach, and
the control unit controls the driving unit such that after the opening of the storage bag held by the holding unit is sealed by the sealing unit, the placement members are separated from each other, and thereafter the placement unit is raised.

10. The paper sheet handling apparatus according to claim 9, wherein
a heat bonding member is provided for thermally bonding and sealing a portion to be a bottom part of the storage bag when the paper sheet is stored therein, and
each placement member is separated from each other after the portion to be the bottom part of the storage bag is sealed by the heat bonding member.

11. The paper sheet handling apparatus according to claim 10, wherein
after the opening of the storage bag held by the holding unit is sealed by the sealing unit, the portion to be the bottom part of the storage bag is sealed by the heat bonding member.

12. The paper sheet handling apparatus according to claim 1, wherein
the control unit controls the driving unit such that after the placement unit is lowered, the placement unit is raised.

13. A paper sheet handling method for storing a paper sheet inside a storage bag provided with an opening comprising the steps of:
holding a portion of the storage bag near the opening thereof by a holding unit, and placing at least a part of the storage bag held by the holding unit on a placement unit that is movable in a substantially vertical direction;
storing a paper sheet inside the storage bag held by the holding unit; and
performing a sealing process for sealing the opening of the storage bag held by the holding unit;
wherein when the sealing process is performed, the placement unit on which at least a part of the storage bag held by the holding unit is placed is raised.
